(19) United States
(12) Patent Application Publication
(10) Pub. No.: US 2008/0253590 A1
(43) Pub. Date: Oct. 16, 2008

(54) SUPERIOR SLIM TYPE OF SPEAKER SLIM HIGH-POWERED AMPLIFIER

(76) Inventor: Szu-Wei Sun, Gueishan Township (TW)

Correspondence Address: Charles G. Mersereau;NIKOLAI & MERSEREAU, P.A., 900 Second Ave. S., #820, Minneapolis, MN, 55402, US

(21) Appl. No.: 11/734,380

(22) Filed: Apr. 12, 2007

(51) Int. Cl. H04R 9/06

(52) U.S. Cl. 381/150

(57) ABSTRACT

A superior slim type of speaker comprises: a baffle, a hole being disposed at a center of the baffle, an vibrating system being disposed at an inner edge of the hole; a voice coil, a periphery of a bottom surface of the vibrating system being connected to a top edge of the voice coil, an outer edge of the voice coil being set a coil, the voice coil being adjacent to two sides of an outer edge of the coil, and the two sides being connected to two lead wires respectively; and a U-type iron member, a loop groove is disposed at a top periphery of the U-type iron member, two sides of the U-type iron member has two gaps respectively, and at least one side of each of the two gaps has an isolating portion; wherein when the U-type iron member is disposed at a bottom of the baffle, the voice coil is elongated to the loop groove in order to let the lead wires outwardly pass through the gaps and be upwardly fastened at a bottom surface of the baffle. As a conclusion, the distance between the lead wires and the U-type iron member are not necessarily considered, so that the length of the voice coil is shortened and the thickness of the whole speaker is decreased as well.

### BACKGROUND OF THE INVENTION

1. Field of the Invention

The present invention generally relates to a superior slim type of speaker, more particularly to a speaker corresponding to other amplifiers with same dimensions or diameters decreases the length of a voice coil so as to make a thinner thickness thereof and can stand a high power input.

2. Description of the Prior Art

With reference to FIG. 6, which is the prior art of an speaker, and includes: a baffle 30, which can be made of plastic material, a hole 301 is disposed at a center of the baffle 30, an vibrating system 302 is disposed at an inner edge of the hole 301; a voice coil 31, the periphery of the bottom surface of the vibrating system 302 is touched to the top edge of the voice coil 31, the outer edge of the bottom of the voice coil 31 is set a coil 311, two sides of the top of the voice coil 30 are connected to two lead wires 312 respectively, and each lead wire 312 is elongated outwardly in order to adhere the free end thereof to the bottom surface of the baffle 30; a U-type iron member 32, which center is disposed a magnet 321, a washer 323 is disposed at the magnet 121, a loop groove 322 is formed between the U-type iron member 32 and the washer 323, and therefore the U-type iron member 32 is embedded at the bottom of the baffle 30 so as to insert the bottom end of the voice coil 30 into the loop groove 322 for avoiding that of the lead wires 312 contacting the U-type iron member 32.

When the voice coil 31 is vibrating and shaking, the lead wires 312 are then easily touched onto the U-type iron member 32 and the magnet 321. Thus a tolerance is a must for shaking the voice coil 31, that is, a distance is existing between the U-type iron member 32 and the baffle 30 so as to prevent the lead wires 312 contacting the U-type iron member 32.

The thicknesses of the baffle 30 and the U-type iron member 32 are not only considered in the prior art, but also the distance between the lead wire 312 and the U-type iron member 32. If not, the length of the voice coil 33 is not shortened and the thickness of the whole speaker is not decreased, therefore a purpose of the slim volume is hardly achieved. The inventor of the present invention thus has developed an advanced technology based on his experience, and the technology will be described as follows.

### SUMMARY OF THE INVENTION

The technical problems to be solved are: a distance between the U-type iron member and the baffle in the prior art is a must for the tolerance of shaking the voice coil and avoiding that of the lead wires contacting the U-type iron member. Such that, the thicknesses of the baffle and the U-type iron member are not only considered in the prior art, but also the distance between the lead wire and the U-type iron member. If not, the length of the voice coil is not shortened and the thickness of the whole speaker is not decreased effectively.

The present invention can solve the problems in the prior art and comprises: a baffle, wherein a hole is disposed at a center of the baffle, an vibrating system is disposed at an inner edge of the hole; a voice coil, wherein a periphery of a bottom surface of the vibrating system is connected to a top edge of the voice coil, an outer edge of the voice coil is set a coil, the voice coil is adjacent to two sides of an outer edge of the coil, and the two sides are connected to two lead wires respectively; and a U-type iron member, which center is disposed a magnet, a washer is disposed at the magnet, a loop groove is formed between the U-type iron member and the washer, two sides of the U-type iron member has two gaps respectively, and at least one side of each of the two gaps has an isolating portion; wherein when the U-type iron member is disposed at a bottom of the baffle, the voice coil is elongated to the loop groove in order to let the lead wires outwardly pass through the gaps and be upwardly fastened at a bottom surface of the baffle. Namely, the distance between the U-type iron member and the baffle is shortened to avoid that of the U-type iron member contacting the lead wires.

The present invention provides the superior slim type of speaker, and the distance between the lead wires and the U-type iron member are not necessarily considered, so that the length of the voice coil is shortened and the thickness of the whole speaker is decreased as well. The present invention comparing to other speakers with same dimensions or diameters relatively has a shorter length of the voice coil and a thinner thickness.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic 3-D view of a first preferred embodiment of the present invention;

FIG. 2 illustrates a schematic exploded view of the first preferred embodiment of the present invention;

FIG. 3 illustrates a schematic sectional view of the first preferred embodiment of the present invention;

FIG. 4 illustrates a schematic view of a bottom surface of the first preferred embodiment of the present invention;

FIG. 5 illustrates a schematic view of a second preferred embodiment of the present invention; and

FIG. 6 illustrates a schematic sectional view of a speaker of prior arts.

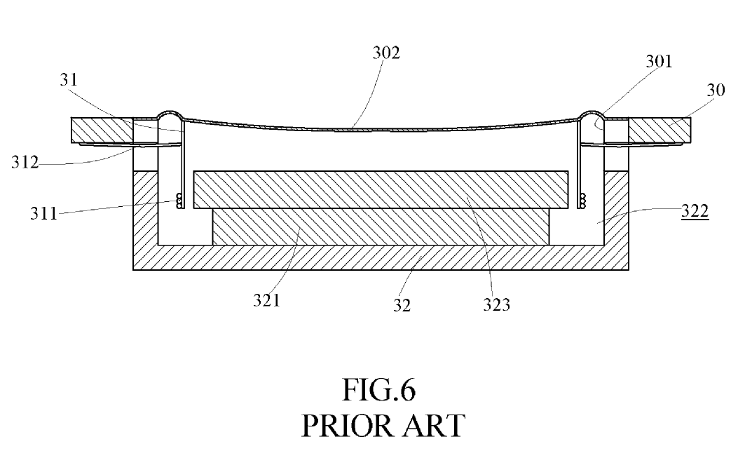

### DETAILED DESCRIPTION OF THE INVENTION

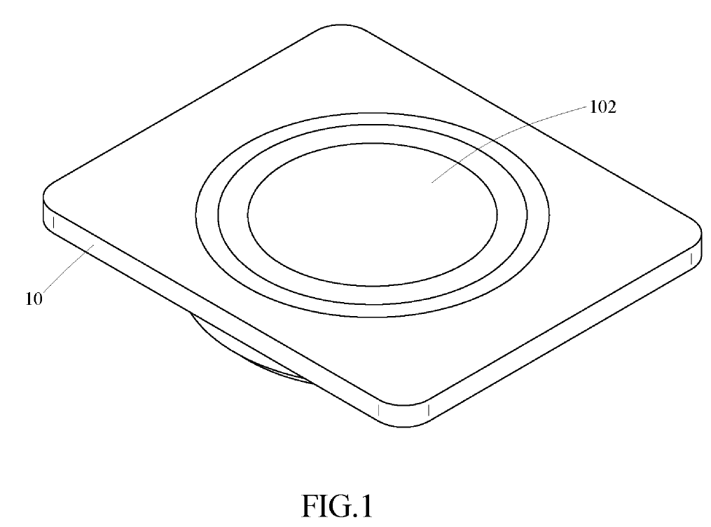

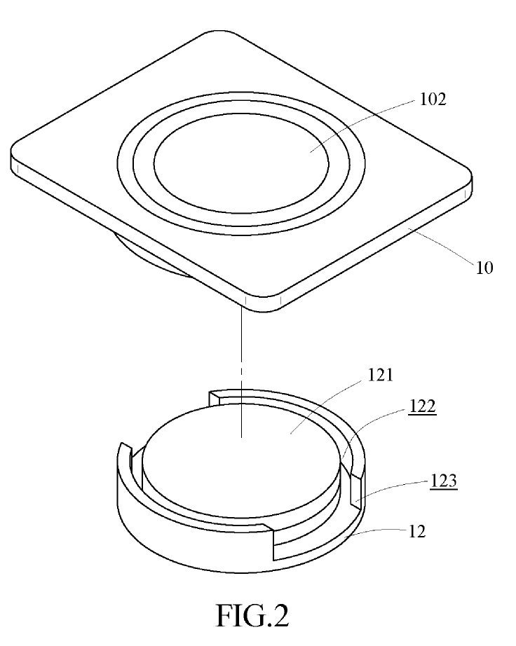

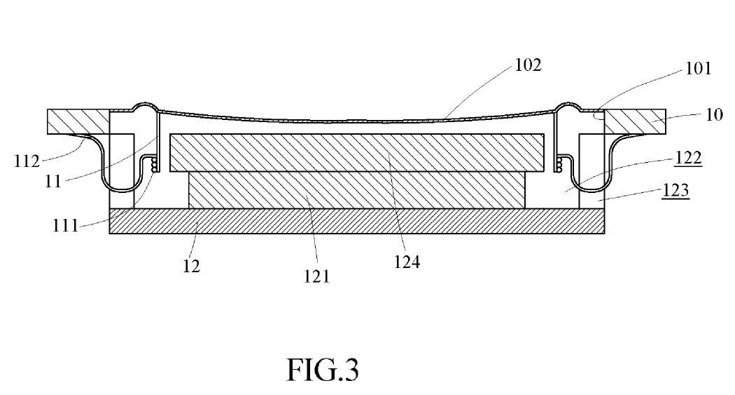

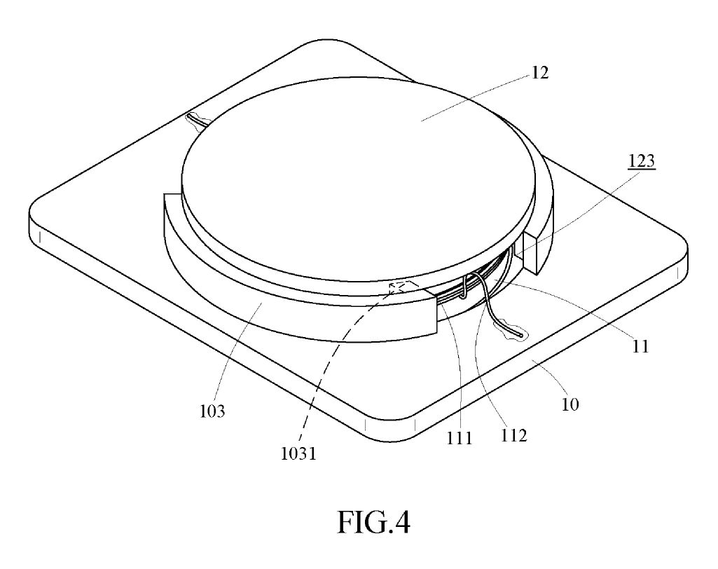

Please refer to FIG. 1 to FIG. 4, the present invention discloses a superior slim type of speaker. The speaker includes: a baffle 10, which can be made of plastic or metal material, a hole 101 is disposed at the center of the baffle 10, as shown in FIG. 3, an vibrating system 102 is disposed at the inner edge of the hole 101; a voice coil 11, the periphery of the bottom surface of the vibrating system 102 is connected to the top edge of the voice coil 11, the outer edge of the voice coil 11 is set a coil 111, the voice coil 11 is adjacent to the two sides of the outer edge of the coil 111, and the two sides are connected to two lead wires 112 respectively, wherein the lead wires 112 are disposed at the coil 111; a U-type iron member 12, which center is disposed a magnet 121, as shown in FIG. 2, a washer 124 is disposed at the magnet 121, a loop groove 122 is between the U-type iron member 12 and the washer 124, the two sides of the U-type iron member 12 have two gaps 123 respectively, and at least the one side of each of the two gaps 123 has an isolating portion 1031; wherein when the U-type iron member 12 is disposed at the bottom of the baffle 10, the voice coil 10 is elongated to the loop groove 122 in order to let the lead wires 112 outwardly pass through the gaps 123 and be upwardly fastened at the bottom surface of the baffle 10, each of the two arc edges of the hole 101 on the bottom surface of the baffle 10 is disposed an isolating block 103, as shown in FIG. 4, and the one end of the isolating block 103 is just disposed at one side of the gap 123 and elongated to become the isolating portion 1031 so as to block the lead wires 112 contacting the gaps 123. Thus the condition of a short circuit can be avoided. One end of the isolating blocks 103 can be disposed at two sides of the one gap 123.

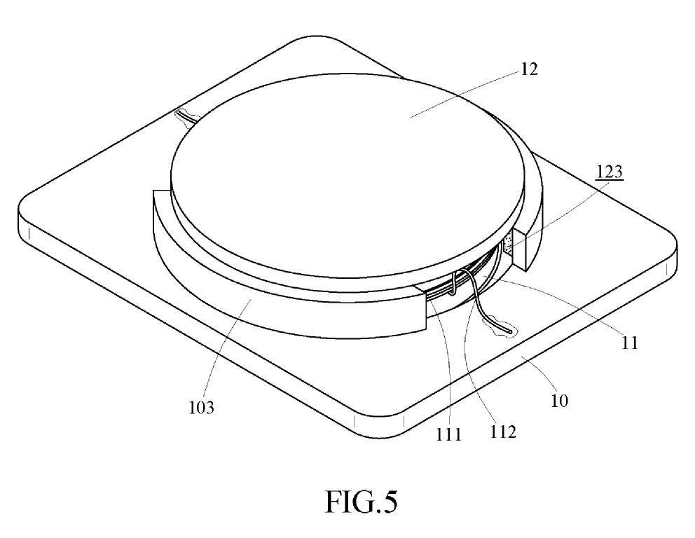

With reference to FIG. 5, to coat the isolating portion 1031 on the peripheries of the gaps 123 are to prevent the lead wires 112 touching the two sides of each of the gaps 123. The isolating portion 1031 can be glue or the like in order to let the lead wires 112 be not touching the gaps 123, wherein the lead wires 112 pass through the gaps 123.

Since the lead wires 112 pass through the gaps 123 of the U-type iron member 12 and are fastened at the bottom surface of the baffle 10, and the lead wires 112 would not touch the two sides of each of the two gaps 123 of the U-type iron member 12 due to the isolating portion 1031. Therefore, even the distance between the U-type iron member 12 and the lead wires 112 is closer, the lead wires 112 will not touch the U-type iron member 12, and the condition of a short circuit can be prevented. That is, the distance between the U-type iron member 12 and the lead wires 112 can be neglected, so that the length of the voice coil 11 is shortened to effectively decrease the thickness of the whole speaker.

According to above descriptions, the present invention can make the speaker shorter then other speaker at the same diameters due to the length of the voice coil is reduced. Therefore, a slim type of speaker is formed.

Further more, each gap of the U-type iron member can be cut to the bottom of the U-type iron member, and the baseline is to avoid the lead wires touching the U-type iron member so as to create the larger oscillating room of the lead wires and thus the solution makes a high power and high quality for this speaker.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A superior slim type of speaker comprising:
a baffle, a hole being disposed at a center of the baffle, an vibrating system being disposed at an inner edge of the hole;
a voice coil, a periphery of a bottom surface of the vibrating system being connected to a top edge of the voice coil, an outer edge of the voice coil being set a coil, the voice coil being adjacent to two sides of an outer edge of the coil, and the two sides being connected to two lead wires respectively; and
a U-type iron member, a loop groove is disposed at a top periphery of the U-type iron member, two sides of the U-type iron member has two gaps respectively, and at least one side of each of the two gaps has an isolating portion;
wherein when the U-type iron member is disposed at a bottom of the baffle, the voice coil is elongated to the loop groove in order to let the lead wires outwardly pass through the gaps and be upwardly fastened at a bottom surface of the baffle.

2. The superior slim type of speaker according to claim 1, wherein each of two arc edges of the hole on the bottom surface of the baffle is disposed an isolating block, and one end of the isolating block is just disposed at one side of the gap and elongated to become the isolating portion so as to block the lead wires contacting the gaps.

3. The superior slim type of speaker according to claim 1, wherein the baffle is made of plastic material.

4. The superior slim type of speaker according to claim 1, wherein the baffle is made of metal material.

5. The superior slim type of speaker according to claim 1, wherein the isolating portion is an isolating substance coated on the gap.

6. The superior slim type of speaker according to claim 5, wherein the isolating substance is glue.
